(19) United States
(12) Patent Application Publication
(10) Pub. No.: US 2020/0097103 A1
(43) Pub. Date: Mar. 26, 2020

(54) Touch pad cell phone

(71) Applicant: James V. Filomio, JR., Bronx, NY (US)

(72) Inventor: James V. Filomio, JR., Bronx, NY (US)

(21) Appl. No.: 16/137,582

(22) Filed: Sep. 21, 2018

(51) Int. Cl. G06F 3/0354; G06F 3/0488; G06F 1/16; H04M 1/02

(52) U.S. Cl. CPC G06F 3/03547; H04M 1/026; G06F 1/1692; G06F 3/04883

(57) ABSTRACT

The Touch Pad cell phone is a touch pad built into the rear of a cell phone that works along with an on-screen cursor that the user can activate with their finger and control the features of their phone one handed.

### BACKGROUND OF INVENTION

The Touch Pad Cell Phone is designed for the user to operate a cell phone with one hand. The Touch Pad on the back of the cell phone allows the user to operate all the phones features with their, example (Index or middle finger). The Touch Pad works along with a cursor that is visible on the front screen. With the Touch Pad a user can control every feature the phone has to offer

The Touch Pad Cell Phone has a touch pad similar to that of a computer along with an On-screen cursor. The Touch Pad is located on the back of the phone. With the built in Touch Pad the user can use one hand to control every option of a phone. The Touch Pad is built into a cell phone and is located on the back of a cell phone. The Touch Pad has a clicking feature, used along with a cursor that allows the user to open or close pages, select a phone option (contacts, online, messages) control applications and settings, programs and displays. The Touch Pad phone is designed for the user to more easily use their phone. The Touch Pad phone was also designed for the user to operate the phone with one hand. The way a cell phone is held, the positioning of the users hands will make the Touch Pad on the back easy to use and found to be readily available.

### BRIEF DESCRIPTION OF SEVERAL VIEWS OF THE DRAWINGS

FIG. 1 of the drawings illustrates the front and rear view of the invention. The rear view shows the touch pad (T). (B) is the touch pads on/off switch that shuts off power to the touchpad. (R) is the cell phone housing and (C) is the camera. Also FIG. 1 illustrates the front view of the said invention. On the front view is the illustration of the cursor (A) that is controlled by the touch pad and that is used to scroll down or up, used to open new pages, close pages, and run every feature the phone has to offer.

### DETAILED DESCRIPTION OF THE INVENTION

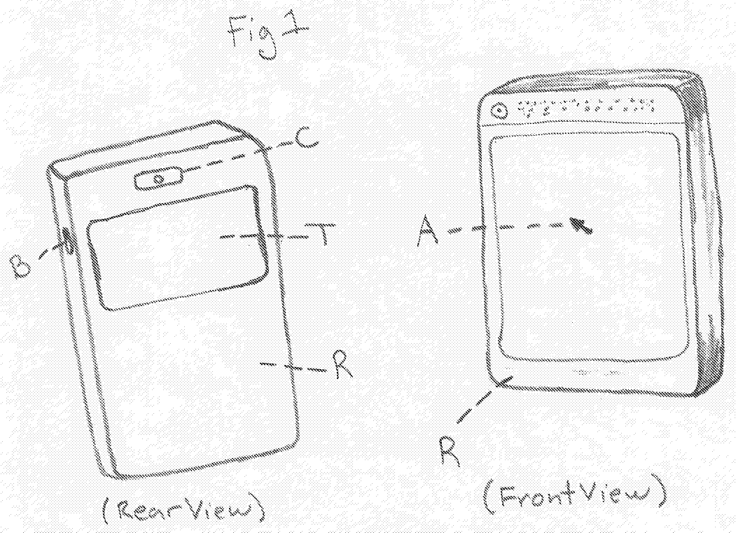

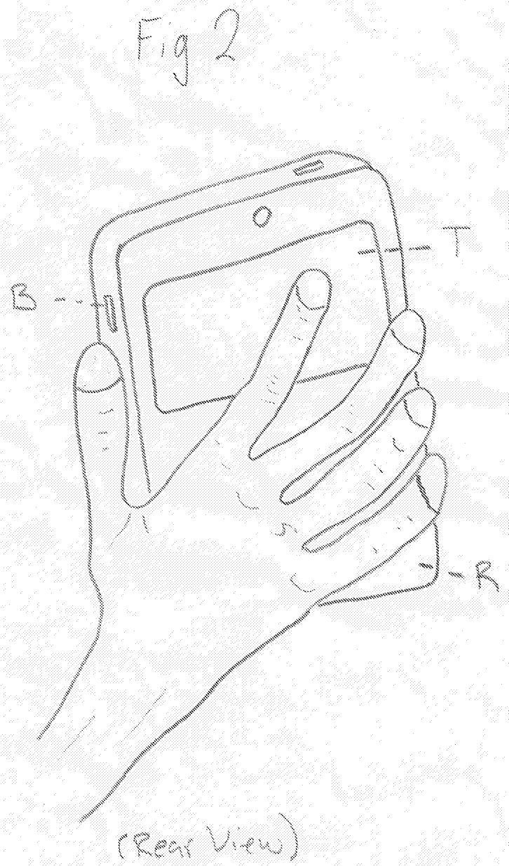

The Touch Pad (T) when operated by the user, will move the cursor (A) FIG. 1. around the cell phone screen and will operate every feature of the phone, example, (windows, Applications, scrolling, settings, play lists . . . )

I claim:

1. A Touch Pad that is built into a cell phone that when activated will control a cursor on the screen that is used to work the features of the phone.
